(19) United States
(12) Patent Application Publication
(10) Pub. No.: US 2024/0384991 A1
(43) Pub. Date: Nov. 21, 2024

(54) PASSIVE TOPOLOGICALLY BIASED SAGNAC INTERFEROMETER AS A ROTATIONAL SENSOR CAPABLE OF SENSING MAGNITUDE AND DIRECTION OF ROTATION

(71) Applicants: Farhad Hakimi, Bedford, MA (US); Hosain Hakimi, Bedford, MA (US)

(72) Inventors: Farhad Hakimi, Bedford, MA (US); Hosain Hakimi, Bedford, MA (US)

(21) Appl. No.: 18/198,230

(22) Filed: May 16, 2023

(51) Int. Cl. G01C 19/72

(52) U.S. Cl. CPC G01C 19/722

(57) ABSTRACT

Many optical gyroscopes are based on an optical Sagnac interferometer configuration including various interferometric fiber-optic gyroscopes (IFOG) to measure magnitude and direction of rotation. IFOGs require active phase modulation in their fiber coil to decipher direction of rotation. This patent document discloses a new type of IFOGs that utilizes a passive topological (also known as geometric) phase shift to sense magnitude and direction of rotation without requiring active phase modulation.

### CROSS REFERENCE TO RELATED APPLICATIONS

This patent document claims the benefit of priority of U.S. Provisional Application No. 63/342,831, entitled, Passive Topologically Biased Sagnac Interferometer As a Rotational Sensor Capable of Sensing Magnitude and Direction of Rotation filed on May 23, 2022, which is incorporated by reference as part of the specification of this patent document.

### FIELD OF THE INVENTION

The invention relates to fiber-optic sensors, Sagnac interferometer, gyroscope, fiber-optic Sagnac interferometry, passively biased fiber-optic gyroscope.

### BACKGROUND OF INVENTION

The so called open loop minimum configuration of the interferometric fiber optic gyroscope (IFOG) was developed at Stanford University in 1981 and is depicted in FIG. 1. A light from a light source exits a 2×2 or 2×1 source coupler/circulator and after going through a 1×2 or 2×2 coil coupler, by a way of a phase modulator, is split into two beams propagate around the fiber optic sensing coil of the gyro in opposite directions. The phase difference between the two light beams is in turn proportional to an input rotation rate about the input axis of the gyro's sensing fiber coil. When not rotating, the interferometer optics insure that both beams traverse the same optical path and thus yield a nominally zero bias for the gyro. In FIG. 1, in order to distinguish between clockwise from counter clockwise rotation in open loop configuration, a phase modulator driven by an electric sinusoidal signal must be placed to one side of the fiber optic sensing coil of the gyro. Applying a sinusoidal voltage to the modulator induces phase modulation onto the light traveling through the optical path of the gyro. The gyro's output is then synchronously demodulated at the first harmonic by a lock-in amplifier. Synchronous demodulation at the first harmonic converts the output of the gyro from that of a raised co-sinusoid to a sinusoidal scale factor. The sinusoidal scale factor is desirable here because of the slope through zero, which is anti-symmetric, placing the gyro at its quadrature point of operation for maximum sensitivity and thereby making it possible to tell the direction of rotation. Another word, without an active phase modulator in FIG. 1, the gyro would not be able to distinguish clockwise from counter clockwise rotation.

The past decades have seen excellent realizations in practical applications of gyroscopic sensors employing active bias, e.g., piezoelectric phase modulator or integrated optics chip (Y-waveguide junction). Light polarization axis in the fiber coil in FIG. 1 must be controlled. Any change in light polarization axis behaves as false rotation signal. Therefore having depolarized light source and depolarizers in the fiber coil improves performance of the IFOG substantially. Therefore an improved version of FIG. 1 embraced by most gyro manufacturers uses all linear high birefringence polarization maintaining (PM) fiber coil and components and thus dropping a need for a polarization control in FIG. 1. PM fiber and components insure state of polarization in fiber do not change due to environmental conditions which as mentioned before cause erroneous rotation signals. However to function effectively, linear PM fibers and components require precise polarization axis alignment between fiber and light polarization axis. In practice alignment is within 0.5 degree which limits performance. Furthermore the polarization maintaining performance of PM fiber drops sharply if length of fiber coil exceeds 3 kilometer. Additionally, extinction ratios of PM couplers should be better than 20 dB to be suitable for use in practical gyro applications. Finally, PM fiber and components are expensive and adds to price of gyro units considerably.

IFOG with PM fiber and components still requires active phase modulation and has several shortcomings and disadvantages.
1) Phase modulators require sinusoidal or square wave signal generator and driver as FIG. 1 indicates. The phase modulator itself is prone to optical bias drifts and requires complex electronic driver counter measures.
2) A practical phase modulator is piezoelectric transducer with standard or PM fiber wrapped around it. The process is mechanical and results in unwanted stresses on the fiber which reduces its longevity.
3) The modulation frequency of piezoelectric transducers is limited. For a fiber coil of 100 meters, the modulation rate is about 1 MHZ (˜100 kHz-km). This is a near upper limit of piezoelectric transducers and consequently length of fiber coil cannot be chosen shorter if reduction of coil length and cost is desired.
4) In a vibration prone environment, the piezoelectric transducer can generate voltages (causing erroneous phase shifts) that obscure the real rotation from fictitious signals.
5) Alternatively, a lithium niobate integrated optical chip phase modulators can be used. While these modulators do not have the mentioned modulation rate limitations of piezoelectric transducers, they are costly and still subject to optical drift due to radiation, thermal stress, and acoustic environment.
6) In some circumstances, it is desirable to have gyro's sensing coil separated from its optoelectronics box. The separation also thermally insulates sensing coil and reduce optical drifts caused by heat of electronic components. Some gyro manufacturers accomplish this by using a tethered optical cable between the sensing coil and its optoelectronics. However, an active phase modulator in gyro sensing coil still requires power to operate. This requires an additional electric cable to sensing fiber coil. This limits the length of tethered cable to a few meters due to concern for electronic noises.

In line for mentioned shortcomings of having phase modulator, Kajioka in 1984 proposed a new IFOG with a passively biased mechanism and thus no phase modulator [1,2]. However the design required having linear PM fiber coil designed for light with linear polarization axis. The device was passively biased at its quadrature point of operation by a bulk optics polarization beam splitter and a quarter wave plate. However, this IFOG suffered from excessive drifts due in part with difficulty aligning polarization axis of light and PM fiber. Additionally no tethered remote gyro sensor coil can be implemented with this approach. Another attempt for IFOG with passive bias was done by Hung-chia-Huang [3] in 2010. His passive bias method involved using a fiber-optic magneto optic faraday rotator performing a nonreciprocal 45 degree rotation, With a zero to fast and a fast to zero quarter wave plates attached to both sides of the integral unit. This method only works with light with circular polarization. Therefore, it requires circular PM fibers and components to operate. Circular PM fibers have proved to be as difficult as their linear PM counterparts to manufacture. Circular PM components also have poorer performance than linear PM parts and currently not being perused for gyro application.

Despite the said setbacks, efforts have never been stopped in attempting to passively bias a Sagnac interferometer for IFOG applications. Rational for passive biasing are strong and includes simplicity and robustness in construction, lower cost, lower noise, easier adjustment, higher accuracy and stability in long-term operation, etc.

### SUMMARY AND OBJECTS OF THE INVENTION

It is therefore the object of the present invention to provide a new open loop minimum configuration IFOG that requires no active phase modulator and no PM fiber in its sensing coil. The present invention utilizes a topological phase approach to achieve passive bias in optical fiber gyroscope. Topological photonics is an emerging research area that focuses on the topological states of classical light and ubiquitous in physics [4]. Although manifestations of this phase have been reported in many different settings [5], perhaps it is in optics where it has had the greatest impact. The concept of topological phase (also known as geometric phase) has been first introduced by Shivaramakrishnan Pancharatnam in 1956 while studying the interference between optical waves of different polarizations [6]. Even though at a first and distracted glance this problem could seem trivial, Pancharatnam unveiled its true complexity, discovering that an optical wave acquires a phase dependent on the path followed by the polarization on the Poincaré sphere.

The additional advantageous of passive bias with standard fiber coil are as follows;
1) With no phase modulation requirement in gyro sensing coil, length of fiber in sensing coil can be chosen arbitrary short or much longer than 3 km limit imposed by PM fiber.
2) No need for alignment to fiber PM axis.
3) With present invention the optical sensor coil and its optoelectronics has the option to reside in two different locations and be connected through a passive optical fiber spanning many meters or kilometers. This also results in reduction in optical drifts due to thermal isolation of gyro sensor coil and its optoelectronics.

### BRIEF DESCRIPTION OF THE DRAWINGS

FIG. 1 is a schematic diagram of a conventional Sagnac interferometric fiber optic gyroscope (IFOG).

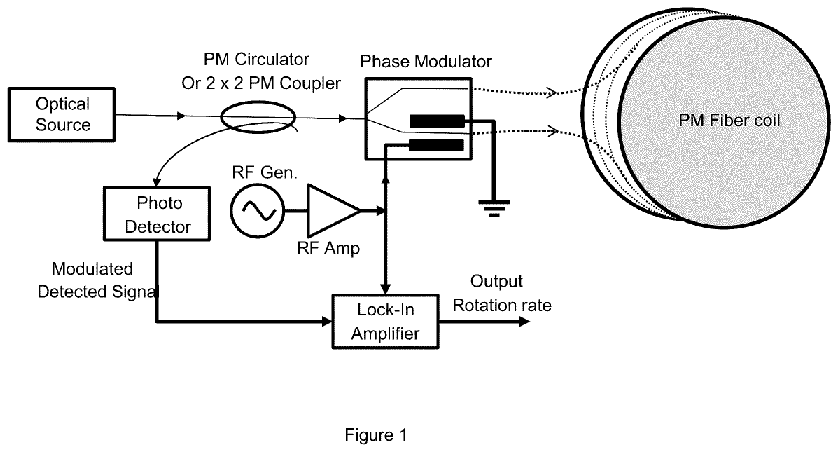

FIG. 2 is a schematic diagram of the present invention fiber-optic gyroscope with topological phase bias element and depolarized light source.

FIG. 3 is a schematic diagram depicting one possible topological phase bias element.

FIG. 4 is a schematic diagram of a passively biased fiber-optic gyroscope based upon present invention with a depolarized light source and tethered single mode optical fiber.

FIG. 5 is a schematic diagram of a passively biased fiber-optic gyroscope based upon present invention with a polarized light source and tethered PM single mode optical fiber.

### DETAILED DESCRIPTION OF THE PREFERRED EMBODIMENT

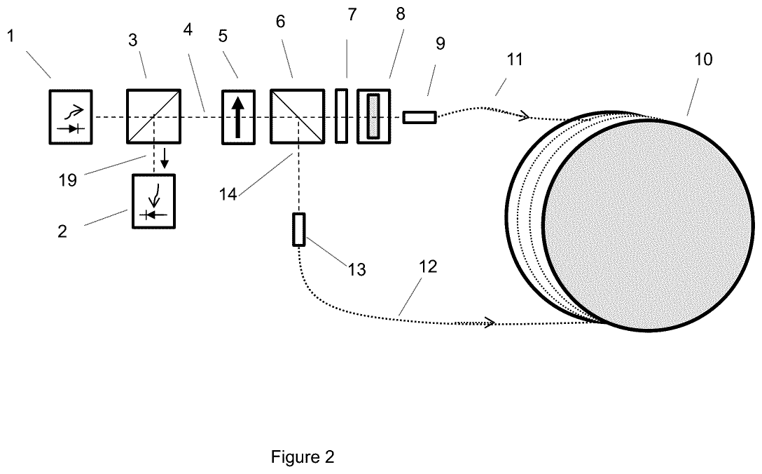

FIG. 2 depicts first preferred embodiment of the present invention. Optical source (1) emanates preferably low coherence depolarized light through optical path (4) that goes through a non-polarizing beam splitter (3), polarizer (5), non-polarizing beam splitter (6), depolarizer (7), a topological phase bias element (8), and fiber coupling element (9). In case path (4) is a collimated free optical space, element (9) is a collimator pigtailed with single mode non PM fiber (11). Light from fiber (11) couples to a non PM single mode optical fiber coil (10) clockwise. Non-polarizing beam splitter (6) also redirects part of light path (4) into light path (14). Light path (14) goes through fiber coupling element (13) which is coupled to single mode non PM fiber (12). Light from fiber (12) reaches coil (10) counterclockwise. Clockwise light from fiber coil (10) goes through optical fiber (12), collimator (13), and through optical path (14) gets redirected back into polarizer (5) by non-polarizing beam splitter (6). Counterclockwise light from coil (10) goes through fiber (11) into collimator (9), depolarizer (7), non-polarizing beam splitter (6) and interfere with clockwise light at polarizer (5). The result of this interference reaches photo detector (2) by way of optical path (4), non-polarizing beam splitter (3) and optical path (19). Since clockwise and counterclockwise paths have crossed the topological phase bias element (8), they each acquire a phase shift topologically. The bias phase shift of the Sagnac interferometer is then the difference between clockwise and counterclockwise topological phase shifts. It should be noted that optical paths (4), (14) and (19) can be free space, optical fibers or integrated optical waveguides. Non-polarizing beam splitter (3) can also be a circulator or 2×1 or 2×2 single mode fiber coupler or an integrated optical waveguide. Non-polarizing beam splitter (6) can be a 1×2 or 2×2 single mode fiber coupler or of integrated optics. Further we can choose non-polarizing beam splitter (6) as a polarizing beam splitter with polarizer (5) rotated by 45 degree respect to it. Depolarizer (7) preferably is of a Lyot type. Depolarizer (7) can also be placed on optical path (14) instead of path (4).

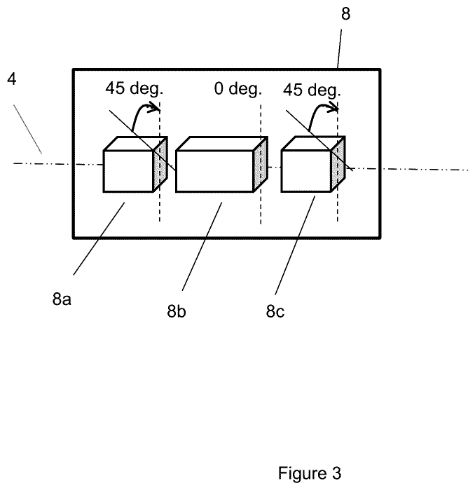

FIG. 3 represents one possible embodiment of topological phase bias element (8). Elements (8a) and (8c) are achromatic quarter wave plates with their optical axis rotated at 45 degrees respect to optical axis of (8b) which is an achromatic half wave plate. The Sagnac interferometer bias phase shift preferably is tuned approximately to 90 degrees by rotating axis of polarizer (5) respect to (8) which set the interferometer in its quadrature point of operation.

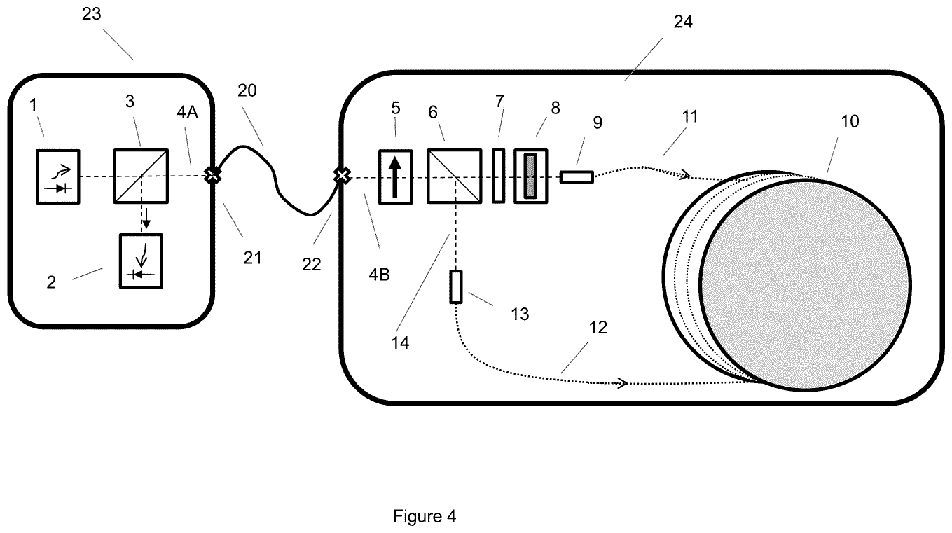

FIG. 4 represents a second preferred and tethered embodiment of the present invention. Here box (23) has a fiber optic bulk head (21), such as FC or LC connector, and is connected to fiber optic bulk (22) through a non PM single mode optical fiber to box (24). Box (23) comprises of depolarized light source (1), non-polarizing beam splitter or circulator (3), and photo detector (2) with same functionality as explained in first embodiment of present invention. Box (24) comprises of polarizer (5), non-polarizing beam splitter (6), depolarizers (7), topological phase bias element (8) and fiber coupling elements (9) and (13) and fiber coil (10) with same functionality as the first embodiment. Optical single mode non PM fiber cable (20) connects light path (4A) on box (23) to (4B) on box (24). If light paths (4A) and (4B) chosen to be optical fibers then connections (21) and (22) can also represent fusion spliced connections.

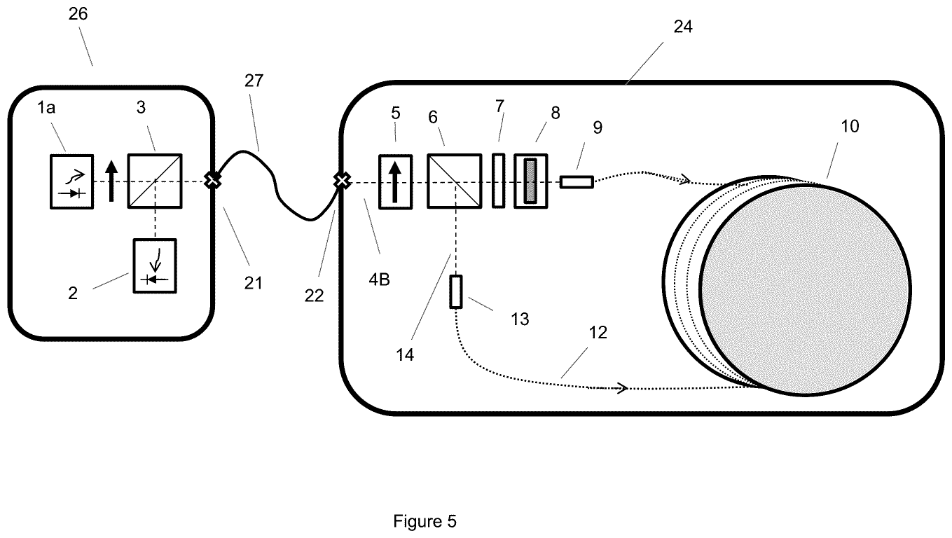

FIG. 5 represents a third preferred and tethered embodiment of the present invention. Here the optical fiber cable (27) represents a single mode PM fiber connecting box (26) to box (24). Box (24) has the same functionality as explained in second embodiment of present invention. Source (1a) in box (26) is linearly polarized and its polarization axis aligned to slow or fast axis of PM fiber cable (27). The PM axis of fiber (27) is also aligned to linear polarization axis of polarizer (5) of box (24). Accordingly, polarization axis of reflected light from box (24) is also aligned to slow or fast axis of PM fiber cable (27).

### REFERENCES

[1] H. Kajioka, “Optical fiber laser gyroscope,” patent 57-78964, 1983.
[2] H. Kajioka, H. Matsumura, “Single polarization optical fiber and its applications,” Hitachi Rev., vol. 33, pp. 215-218, 1984.
[3] Hung-chia-Huang (patent #U.S. Pat. No. 7,679,753 B2)
[4] Geometric phases of light, Insights from fiber bundle theory—C. Cisowski, J. B. Götte, and S. Franke-Arnold Rev. Mod. Phys. 94, 031001-Published 18 Jul. 2022
[5] Shapere, A., Wilczek, F., 1989, Geometric Phases in Physics, World Scientific, Singapore
[6] S. Pancharatnam, Proc. Indian Acad. Sci. A 1956, 44, 0370.

The invention claims are:

1. A fiber optic Sagnac interferometer passively biased through topological phase.

2. A passively biased Sagnac interferometer comprising:
a light source;
a photo detector;
a linear polarizer
a depolarizer
a topological phase bias element
a fiber coil;
a first non-polarizing beam splitter/circulator;
a second non polarizing beam splitter;
output of said light source optically connected to input of a non-polarizing first beam splitter/circulator;
reflection output of first said beam splitter optically connected to said photo detector;
transmission output of the said first beam splitter/circulator optically connected to input of said linear polarizer;
output of said linear polarizer optically connected to input of a second non-polarizing beam splitter;
transmission output of said second beam splitter optically connected to input of said depolarizer;
output of said depolarizer optically connected to said topological phase bias element;
output of said topological phase bias element optically connected to first input of said fiber coil;
reflection output of said second beam splitter optically connected to second input of said fiber coil.

3. Apparatus of claim 2, wherein light source is depolarized.

4. Apparatus of claim 2, wherein light source is linearly polarized and aligned to axis of said linear polarizer.

5. A tethered passively biased Sagnac interferometer comprising:
output of said light source optically connected to input of a non-polarizing beam splitter/circulator residing in said first box;
reflection output of said beam splitter optically connected to said photo detector;
transmission output of the said beam splitter optically connected to first input end of a fiber cable tethered outside of said first box;
the second optics box optically connected to second end input of said tethered fiber cable;
residing in said second optics box, a linear polarizer, a non-polarizing beam splitter, a depolarizer, a topological phase bias element, a non PM single mode fiber coil;
output of said linear polarizer optically connected to input of non-polarizing beam splitter;
transmission output of said beam splitter optically connected to input of said depolarizer;
output of said depolarizer optically connected to said topological phase bias element;
output of said topological phase bias element optically connected to first input of said fiber coil;
reflection output of said beam splitter optically connected to second input of said fiber coil.

6. A tethered passively biased Sagnac interferometer of claim 5, wherein light source is depolarized.

7. A tethered passively biased Sagnac interferometer of claim 6, wherein optical cable is a single mode fiber.

8. A tethered passively biased Sagnac interferometer of claim 5, wherein light source is polarized.

9. A tethered passively biased Sagnac interferometer of claim 8, wherein the optical fiber cable residing outside of first said optoelectronic box is a PM single mode fiber with its axis aligned to polarization axis of said polarized light source.

10. A tethered passively biased Sagnac interferometer of claim 9, wherein polarization axis of said PM single mode fiber cable is aligned to said polarizer in second optics box.
